(19) United States
(12) Patent Application Publication
(10) Pub. No.: US 2012/0121898 A1
(43) Pub. Date: May 17, 2012

(54) POLYMER MATERIAL, METHOD FOR IN SITU FUNCTIONALISATION OF POLYMER MATERIALS AND ALSO USE THEREOF

(75) Inventors: Andrea Burdack-Freitag, Holzkrichen (DE); Andreas Schmohl, Munchen (DE); Michael Rampfl, Grosskarolinenfeld (DE); Klaus Breuer, Aschau (DE)

(73) Assignee: FRAUNHOFER-GESELLSCHAFT ZUR FORDERUNG DER ANGEWANDTEN FORSCHUNG E.V., Munchen (DE)

(21) Appl. No.: 13/297,050

(22) Filed: Nov. 15, 2011

(30) Foreign Application Priority Data
Nov. 17, 2010 (DE) 10 2010 051 648.1

(51) Int. Cl. B32B 5/00; C08G 73/02; C08G 63/91; C08F 16/06; C08F 10/00; C08G 64/42; C08G 59/14; C08F 12/08; C08G 77/38; C08F 20/10; C08G 69/48; C08G 18/00

(52) U.S. Cl. 428/339; 525/420; 525/540; 525/418; 525/61; 525/452; 525/461; 525/403; 525/523; 525/55; 525/474; 525/54.21

(57) ABSTRACT

The present invention relates to a polymer material with a functionalised surface and also to a method for in situ functionalisation of polymer materials. Furthermore, the invention comprises the use of the polymer materials.

The invention relates to a polymer material with a functionalised surface and also to a method for in situ functionalisation of polymer materials. Furthermore, the invention comprises the use of the polymer materials.

Polymer materials are used in various ways. Polymers with terminal furanones are described in WO 2007/133777 A1. Furthermore, this unexamined German application includes compositions which comprise these polymers and which are used for textile production, for medical devices, supply or delivery means, packaging material, casings for such and similar objects.

In DE 697 22 233 T2, a polyfunctional urethane-containing composition is described, which can be produced in a two-stage method, and also methods for surface coating, for production of stabilised lattices and also cured polymer resins.

In “Synthesis and characterization of fluorocarbon chain end-capped poly(carbonate urethane)s as biomaterials: A novel bilayered surface structure” by X. Xie, H. Tan, J. Li, Y. Zhong, Journal of biomedical materials research, Part A (2008), 84(1), 30-43, it was shown that there is a surface concentration terminally of fluorinated polymers. Furthermore, different analyses for characterisation of the surface and of the bulk are shown.

The methods and also polymer materials known from the state of the art do not make a directed layer construction possible. Furthermore, a change in the bulk properties can be effected with the known methods.

Starting herefrom, it is the object of the present invention to eliminate the disadvantages of the state of the art and to provide polymer materials and also methods for production thereof, in which modification of the surface properties is implemented in situ, the bulk properties, such as e.g. statics and gloss, being maintained.

This object is achieved by a method having the features of claim 1. Claim 6 relates to a polymer material, claim 10 to the use of the polymer material. Further advantageous embodiments are contained in the dependent claims.

According to the invention, a method is provided for in situ functionalisation of polymer materials in a polymer-forming reaction and/or crosslinking reaction based on an addition- or condensation reaction, in which at least one polymer former is selected from the group consisting of lactams, diamines, dicarboxylic acids, dicarboxylic acid chlorides, vinyl alcohols, diols, diesters, diisocyanates, diarylcarbonates, imides, epoxides, diepoxides, dicarboxylic acid anhydrides and oligomers or polymers constructed from those monomers, is converted with at least one modifier selected from the group consisting of alcohols (C₁-C₂₀), fluorinated alcohols (C₁-C₂₀), acids (C₁-C₂₀), fluorinated acids (C₁-C₂₀), acid anhydrides (C₁-C₂₀), fluorinated acid anhydrides (C₁-C₂₀), primary amines (C₁-C₂₀), fluorinated primary amines (C₁-C₂₀), secondary amines (C₁-C₂₀), fluorinated secondary amines (C₁-C₂₀), tertiary amines (C₁-C₂₀), fluorinated tertiary amines (C₁-C₂₀), isocyanates (C₁-C₂₀), fluorinated isocyanates (C₁-C₂₀), thioisocyanates (C₁-C₂₀), fluorinated thiocyanates (C₁-C₂₀), carbonyls (C₁-C₂₀), fluorinated carbonyls (C₁-C₂₀), substituted arylene, fluorinated substituted arylene, unsubstituted arylene, fluorinated unsubstituted arylene, epoxides, multifunctional compounds, in particular glycols, polyols, saccharides, oligosaccharides, polysaccharides, diamines, polyamines, mixed functional compounds and/or mixtures hereof, polymer formers and modifiers being present in phases which are not miscible with each other so that essentially terminal covalent bonding of the at least one modifier to the at least one polymer former is effected at the interface of the phases, as a result of which the at least one modifier accumulates essentially on the surface of the polymer material.

As a result of this method, it is made possible that the bonding of the components is effected in a directed manner at the phase boundary or on the surface. According to the invention, the modified polymer regions can consequently be concentrated essentially on the surface of the polymer.

In a preferred variant of the method, the polymer former has been modified in advance and the thus modified polymer former is converted with unmodified polymer formers, both being present in phases which are not miscible with each other so that bonding of the previously modified polymer former to the unmodified polymer former is effected at the interface of the phases.

A covalent bonding to functional groups of the polymer is thus made possible, in which the surface modification is effected during the production process and not by a complex plasma surface treatment.

Preferably, the modifier or the modified polymer former is added at the beginning, during and/or immediately before conclusion of the polymer-forming reaction and/or crosslinking reaction. In this way, complete conversion of the modifier or of the modified polymer former is ensured.

In an advantageous embodiment, the polymer-forming reaction and/or crosslinking reaction based on an addition- or condensation reaction is effected because of a nucleation. This nucleation can be effected thermally, photochemically, catalytically, oxidatively and/or radically.

According to the invention, at least one prepolymer (polymer precursor) can therefore be converted with at least one modified prepolymer, the modified prepolymer being concentrated on the surface or interface and subsequently crosslinking between prepolymer and modified prepolymer being effected.

Alternatively, also a conversion of at least one prepolymer 1, at least one prepolymer 2 and at least one modifier is possible, the modifier firstly reacting with the prepolymer 1 and subsequently concentration of the modified prepolymer 1 being effected on the surface or interface or phase boundary. Finally, crosslinking of modified prepolymer 1 with prepolymer 2 is effected.

There are understood by prepolymers according to the invention, components which represent precursors of polymers. There are included herein polymer precursors, such as monomers or monomer systems which have reacted further possibly in advance to form an average-length polymer chain consisting of 2 to 1,000 monomer units. This material has the ability to crosslink further by polymerisation to form a completely formed polymer with the properties according to the invention.

It is also possible that at least one monomer 1, at least one monomer 2 and at least one modifier are present, firstly covalent bonding of the modifier to the monomer 1 and subsequently concentration of the modified monomer 1 being effected on the surface or interface or phase boundary and subsequently a polymerisation and also a crosslinking being implemented.

In a further preferred embodiment, at least one prepolymer and at least one modifier are used. After concentration of the modifier on the surface or interface or phase boundary, the reaction of the modifier with the prepolymer takes place and finally crosslinking.

Furthermore, also at least one monomer can be converted with at least one modifier, firstly concentration of the modifier on the surface or interface or phase boundary being effected and subsequently the reaction of the modifier with the monomer taking place. After the subsequent polymerisation, crosslinking of the polymerised components is effected.

It is also conceivable that at least one prepolymer and at least one modifier are converted with each other, firstly covalent bonding of the modifier to the prepolymer being effected and subsequently the modified prepolymer being concentrated on the surface or interface or phase boundary. Subsequently thereto, crosslinking of the modified prepolymers is effected.

The prepolymers and also the monomers can be assigned, according to the invention, to the polymer formers.

Furthermore, the invention includes a polymer material with a functionalised surface, producible according to the described method.

This polymer material preferably has a self-organised layer of the modifier or of the modified polymer former on the surface.

The polymer material is preferably selected from the group consisting of polycarbonates, polyesters, polyacrylates, polyolefins, polyurethanes, polystyrenes, polyamides, polyaramides, polyethers, polysiloxanes and blends, alloys, co-, graft- and block copolymers thereof.

These polymer materials can be used in various ways. Because of these materials, the problem of migration, diffusion and permeation of emissions by plastic materials, such as for example pipelines, can be prevented.

In one embodiment, the functionalised surface of the polymer material has a layer thickness between 0.1 nm and 500 nm, preferably 1 nm to 50 nm. These have a uniform chemical bond and a characteristic depth profile and also an ordered surface structure.

Furthermore, the invention includes the use of the described polymer material for functionalisation of substrate surfaces, in particular as dirt- or water-repellent surface.

For this use, the substrate preferably consists of an organic or inorganic material, in particular metal, concrete, glass, stone, wood, polymer material, ceramic, composite material, rubber and/or comprises this.

The technical applications for this are varied. For example, the icing-up of aircraft can thus be prevented. Furthermore, such surfaces make possible a dirt-repellent effect on household appliances. One application possibility for lorries and rail vehicles resides in the interior and exterior region of vehicle construction and also in shipbuilding. A further possibility is the use of such functionalised polymer materials as barrier layers for reducing material emissions (diffusion barrier, permeation barrier). These polymer materials can be used in paint systems, on glasses, panes of glass, metal surfaces and metal claddings. Further possibilities for use are kitchen worktops, refrigerators, mirrors, furniture and exposed concrete. Also building facades and interior surfaces can be coated with these polymer materials. A further possibility for use resides in the field of laboratory equipment and laboratory materials (e.g. exchanger resins). Furthermore, these polymer materials can be used for headlights, windscreens, domed skylights, slates on buildings and also in general on building facades.

The subject according to the application is intended to be explained in more detail with reference to the following Figures, without restricting said subject to these special variants.

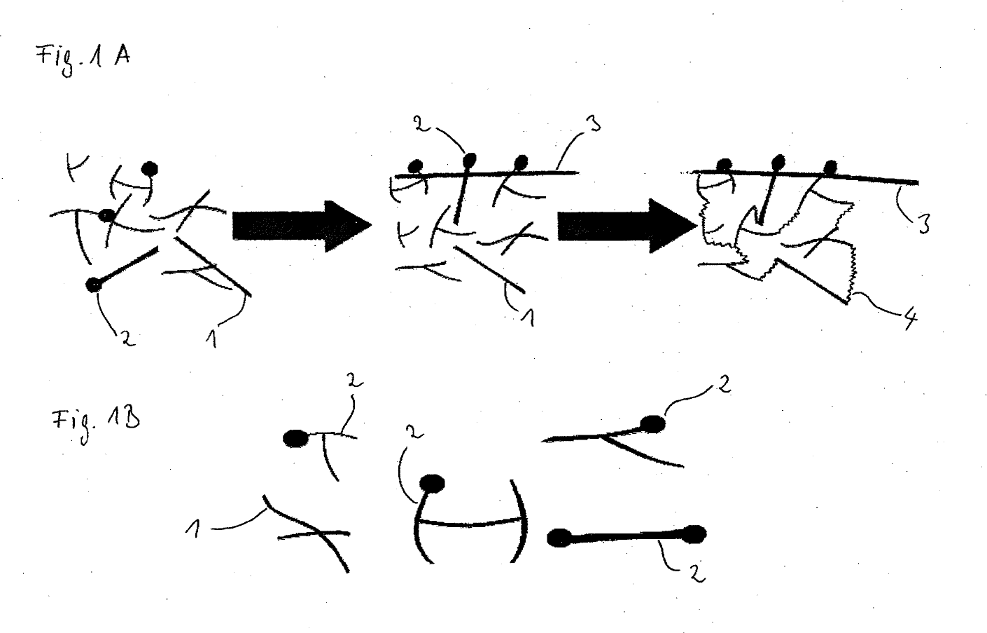

FIG. 1A shows a possible, schematic course of a reaction according to the invention.

FIG. 1B shows possible reaction partners for a reaction according to the invention.

In FIG. 1A, it is represented schematically how the reaction according to the invention can proceed. In a first step, self-organisation of the modified polymer formers 2 on the surface or interface or phase boundary is effected, whereas the unmodified polymer formers 1 are present distributed. Crosslinking 4 of the unmodified polymer formers 1 and of the modified polymer formers 2 is effected thereafter.

FIG. 1B shows several variants for the unmodified polymer formers 1 and also the modified polymer formers 2.

1. A method for in situ functionalization of polymer materials in a polymer-forming reaction and/or crosslinking reaction based on an addition- or condensation reaction, in which
at least one polymer former is selected from the group consisting of lactams, diamines, dicarboxylic acids, dicarboxylic acid chlorides, vinyl alcohols, diols, diesters, diisocyanates, diarylcarbonates, imides, epoxides, diepoxides, dicarboxylic acid anhydrides and oligomers or polymers constructed from those monomers, is converted with
at least one modifier selected from the group consisting of alcohols (C₁-C₂₀), fluorinated alcohols (C₁-C₂₀), acids (C₁-C₂₀), fluorinated acids (C₁-C₂₀), acid anhydrides (C₁-C₂₀), fluorinated acid anhydrides (C₁-C₂₀), primary amines (C₁-C₂₀), fluorinated primary amines (C₁-C₂₀), secondary amines (C₁-C₂₀), fluorinated secondary amines (C₁-C₂₀), tertiary amines (C₁-C₂₀), fluorinated tertiary amines (C₁-C₂₀), isocyanates (C₁-C₂₀), fluorinated isocyanates (C₁-C₂₀), thioisocyanates (C₁-C₂₀), fluorinated thioisocyanates (C₁-C₂₀), carbonyls (C₁-C₂₀), fluorinated carbonyls (C₁-C₂₀), substituted arylene, fluorinated substituted arylene, unsubstituted arylene, fluorinated unsubstituted arylene, epoxides, multifunctional compounds, glycols, polyols, saccharides, oligosaccharides, polysaccharides, diamines, polyamines, mixed functional compounds and/or mixtures hereof,
the polymer formers and modifiers being present in phases which are not miscible with each other so that essentially terminal covalent bonding of the at least one modifier to the at least one polymer former is effected at the interface of the phases,
as a result of which the at least one modifier accumulates essentially on the surface of the polymer material.

2. The method according to claim 1,
wherein the polymer former has been modified in advance and the thus modified polymer former is converted with unmodified polymer formers,
both being present in phases which are not miscible with each other so that bonding of the previously modified polymer former to the unmodified polymer former is effected at the interface of the phases.

3. The method according to claim 1,
wherein the modifier or the modified polymer former is added at the beginning, during and/or immediately before conclusion of the polymer-forming reaction and/or crosslinking reaction.

4. The method according to claim 1,
wherein the polymer-forming reaction and/or crosslinking reaction based on an addition- or condensation reaction is effected because of a nucleation.

5. The method according to claim 4,
wherein the nucleation is effected thermally, photochemically, catalytically, oxidatively and/or radically.

6. A polymer material with a functionalized surface, producible according to claim 1.

7. The polymer material according to claim 6,
wherein the polymer material has a self-organized layer of the modifier or of the modified polymer former on the surface.

8. The polymer material according to claim 6, wherein the polymer material is selected from the group consisting of polycarbonates, polyesters, polyacrylates, polyolefins, polyurethanes, polystyrenes, polyamides, polyaramides, polyethers, polysiloxanes and blends, alloys, and co-, graft- and block copolymers thereof.

9. The polymer material according to claim 6, wherein the functionalized surface has a layer thickness between 0.1 nm and 500 nm.

10-11. (canceled)

12. A method of functionalizing a substrate surface comprising utilizing the polymer material according to claim 6 in a functionalizing step.

13. The method of claim 12, wherein the substrate is an organic material or an inorganic material.

14. The method of claim 12, wherein the substrate is selected from the group consisting of metal, concrete, glass, stone, wood, polymer material, ceramic, composite material, and rubber.

15. The polymer material according to claim 9, wherein the functionalized surface has a layer thickness between 1 nm to 50 nm.
